(19) United States
(12) Patent Application Publication
(10) Pub. No.: US 2018/0121885 A1
(43) Pub. Date: May 3, 2018

(54) REPAIR MONITOR

(71) Applicant: GREGORY BACO, DUNCAN, SC (US)

(72) Inventor: GREGORY BACO, DUNCAN, SC (US)

(21) Appl. No.: 15/339,206

(22) Filed: Oct. 31, 2016

(51) Int. Cl. G06Q 10/00; H04B 7/26

(52) U.S. Cl. CPC G06Q 10/20; H04B 7/26

(57) ABSTRACT

This invention relates to a method for providing communication between a mobile computing device and a vehicle service facility. Further, the method is adapted identify vehicle service time and display a vehicle service alert on the user device. Further, the user can send a vehicle service request to at least one service vendor device provided by the mobile application. The method is adapted to determine the status of the vehicle service process in real time and display the status to the user upon receiving a request to view a vehicle service status.

### BACKGROUND OF THE INVENTION

### (1) Field of the Invention

The present disclosure relates communication between a vehicle service center and a mobile computing device and more particularly relates to providing status information regarding a vehicle service status to the user device.

### (2) Background of the Invention

Conventionally, a customer will arrive at an automobile repair shop or service center and request automobile services. The service advisor will make a brief determination of the necessary parts and labor needed to complete the repair after performing a preliminary evaluation of what the customer needs. The service advisor performs a repair estimate, creates an initial repair order, dispatches the work to a service technician, and monitors the progress of the repair. The service advisor also communicates the progress of repair back to the customer and serves as a point of contact. Upon completion of the servicing, the service advisor explains the services performed and supervises the return of the vehicle to the owner.

A significant amount of valuable information is acquired during the process of an automobile service provider repairing and maintaining automobiles. Over time, a historical database can be created regarding the repair and maintenance history for any given customer and for any given model and year of any automobile as services are provided. This information has monetary value in that there is a demand for such information by customers, parts suppliers, automobile manufacturers, automobile dealers, and insurance companies. However, the time and effort required to document, store, retrieve, and communicate this information are excessively expensive for the broad, rapid commercial distribution of such information. Although information can be exchanged rapidly and cheaply over the Internet, the internet has not heretofore been useful in the dissemination of historical data related to automobile repair and maintenance.

Further, a repair shop normally provides an estimated completion date to the owner of the vehicle at the time the initial damage estimate is prepared. However, many times, the estimated completion date need to be adjusted due to additional damage that is identified when the vehicle is dismantled or when there is a delay in obtaining parts for the vehicle. Repair shops are generally not equipped to contact the vehicle owner to inform the owner that delays are being experienced in the repair of the vehicle, and the owner is unaware of the status of the vehicle during the time in which it is undergoing repair in the shop. This lack of communication between the repair shop and the vehicle owner can lead to dissatisfaction with the repair shop by the vehicle owner.

Currently, persons who bring their vehicle to a vehicle service station or a repair shop must wait for their vehicle for at least one working day. Customers do not know whether the vehicle could be fully serviced within the same working day, and if so, at what hour. As such, customers are forced to keep calling the vehicle repair shop for a status report. This causes repair shop personnel to field a lot of calls throughout the day. Not only do the calls disrupt the personnel's work, it also causes uncertainty and inconvenience for a customer trying to plan their daily schedule.

The operation of smart phone communication is well known in the art, and the following prior art is hereby incorporated by reference for their supportive teachings to the following disclosed invention in this application, whereby:

U.S. Patent application 2013/0109356, published on May 2, 2013, by Patterson et al., teaches of a system and method of maintaining communications policy setting in a wireless network.

U.S. Pat. No. 8,958,782, issued Feb. 17, 2015, by Kirchhoff et al., teaches of a method and system for blocking unwanted communications.

U.S. Pat. No. 8,644,485, issued Feb. 4, 2014, by Vendrow et al., teaches of an intelligent softswitch for managing a call.

U.S. Pat. No. 8,799,406, issued Aug. 5, 2014, to Slonh, teaches of a method and apparatus of providing notification services to smartphone devices.

Accordingly, improved communications are desired between the repair shop and the vehicle owner to enhance customer satisfaction.

### SUMMARY OF THE INVENTION

The feature of the present invention to overcome the deficiencies of the prior art and to provide a system and method for checking vehicle service status of a user's vehicle in at least one vendor facility. As such, the general purpose of the present invention, which will be described subsequently in greater detail, is to provide a new and method online monitoring vehicle service status, which has all the advantages of the prior art and none of the disadvantages.

A potential feature of the invention is to provide a computer-implemented method for checking vehicle service status of a user's vehicle in at least one vendor facility, the method allows at least one service vendor device to receive a vehicle service request from at least one user device through a server via wireless communication. The method is adapted to create a vehicle service process for the user vehicle based on the vehicle service request, wherein the vehicle service process includes a plurality of vehicle service event for the user vehicle based on the vehicle service request. Further, the method is adapted to store the plurality of vehicle service event to a database. Further, the method is adapted to receive status for each of the plurality of vehicle service event of the user vehicle from at least one vendor device present the at least one vendor facility. The method is adapted to store the status for each of the plurality of vehicle service event of the user vehicle in the database. Further, the method is adapted to receive a request from the user device to view a vehicle service status. Further, the method is adapted retrieve the status for each of the plurality of vehicle service event from the database. The method is adapted to transmit the status for each of the plurality of vehicle service event to the user device. Thereafter, the method is adapted to display the status for each of the plurality of vehicle service event on the user device.

It is another potential feature of the present invention to provide a module of a software application that allows customers to schedule service appointments for their vehicle, so that when the customer brings his vehicle into a vehicle repair shop or vendor facility, the vendor can register the customer's vehicle into a software database to allow the dealer to communicate with the customer and exchange media data (pictures, video, sound) over a network. The vendor can also alert the customer of the status of the vehicle's service progress. The customer can see a status bar indicating the progress of his vehicle service and the expected completion time of the repairs. There is also an option to pay for the vehicle repair service through the online payment gateway.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty that characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic diagram of example systems for providing communication between a vehicle service facility and a mobile computing device, according to the various embodiments of the present invention; and

FIG. 2 illustrates a screen shot of the status interface and a status update of the vehicle service process, according to the various embodiments of the present invention.

### DETAILED DESCRIPTION OF THE INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present disclosure sets forth various systems, apparatuses, and methods for providing communication between a mobile computing device and a vehicle service facility. In one embodiment, the mobile application is adapted identify vehicle service time and display a vehicle service alert on the user device. Further, the user can send a vehicle service request to at least one service vendor device provided by the mobile application. The mobile application is adapted to determine the status of the vehicle service process in real time and display the status to the user upon receiving a request to view a vehicle service status.

In one embodiment of the present invention, a module of a software application running on the user device that allows user to schedule service appointments for their vehicle with at least one vendor service facility, so that when the customer brings his vehicle into a vehicle repair shop or vendor facility, the vendor can register the customer's vehicle into a software database to allow the dealer to communicate with the customer and exchange media data (pictures, video, sound) over a network. The vendor can also alert the customer of the status of the vehicle's service progress. The customer can see a status bar indicating the progress of his vehicle service and the expected completion time of the repairs. There is also an option to pay for the vehicle repair service through the online payment gateway.

Further, the mobile application is adapted to store account information corresponding to one or more vehicles in a database, wherein the database may be stored in the memory of the user device or in the server database. In one embodiment, the mobile application links the mobile a user device to a specific account. In one embodiment, information corresponding to the user account stored by the mobile application is used for login and authentication of the user.

The present invention concerns implementing a method for checking vehicle service status of a user's vehicle in at least one vendor facility, the method allows at least one service vendor device to receive a vehicle service request from at least one user device through a server via wireless communication. The method is adapted to create a vehicle service process for the user vehicle based on the vehicle service request, wherein the vehicle service process includes a plurality of vehicle service event for the user vehicle based on the vehicle service request. Further, the method is adapted to store the plurality of vehicle service event to a database. Further, the method is adapted to receive status for each of the plurality of vehicle service event of the user vehicle from at least one vendor device present the at least one vendor facility. The method is adapted to store the status for each of the plurality of vehicle service event of the user vehicle in the database. Further, the method is adapted to receive a request from the user device to view a vehicle service status. Further, the method is adapted retrieve the status for each of the plurality of vehicle service event from the database. The method is adapted to transmit the status for each of the plurality of vehicle service event to the user device. Thereafter, the method is adapted to display the status for each of the plurality of vehicle service event on the user device.

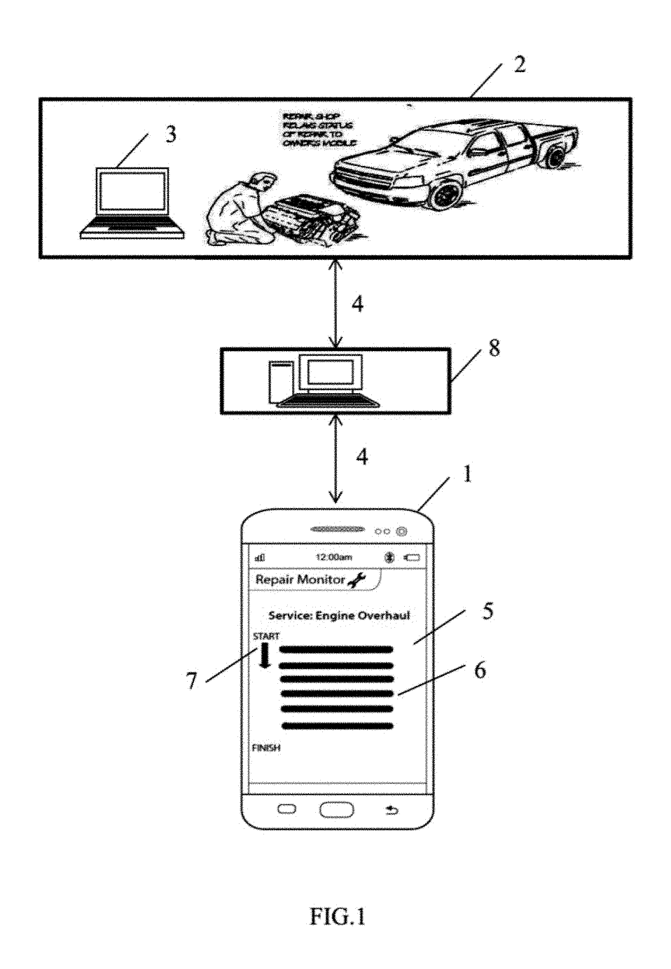

FIG. 1 depicts a schematic diagram of an example of a system for providing communication between at least one vendor facility 2 and a user device 1. The system includes a vendor communication device 3, like a desk top computer as illustrated, a user device 1, like a smart phone or computer pad, a computer server 8, like a network provider, that is coupled through a communications network 4 (e.g. wired/wireless communication, telecommunication, world wide web, cellular communications, and the like). According to one embodiment, the vendor device 3 is configured to communicate with the user device 1 via server 8 through the communication network 4 to provide service status information and/or other information regarding a vehicle service appointment, vehicle accessories, vehicle insurance, costing, estimate time, deals, service coupon, pick and drop, spare parts cost and availability and the like to a user of the user device 1.

The user device 1 and vendor device 3 may include a smart phone, tablet computer, desktop, laptop, or any other computing device. In one embodiment, for example, the mobile computing device 1 may be running a mobile operating system such as Android®, iOS®, Windows®, or any other mobile operating system. The user device 1 may be configured to communicate over a wireless network 4 such as a mobile communications network, cellular network, or another wireless network.

In one embodiment, the user device 1 includes a mobile application 5 that receives vehicle status information and displays the status on the user device 1. The mobile computing application 5 may also provide functions for scheduling an appointment, viewing the location of at least one vendor facility, paying for service via user device 1, searching vendor facility of a dealership based on the user location, vehicle pick and drop and/or the like. In one embodiment, the mobile computing application comprises code installed and/or executed natively on the user device 1.

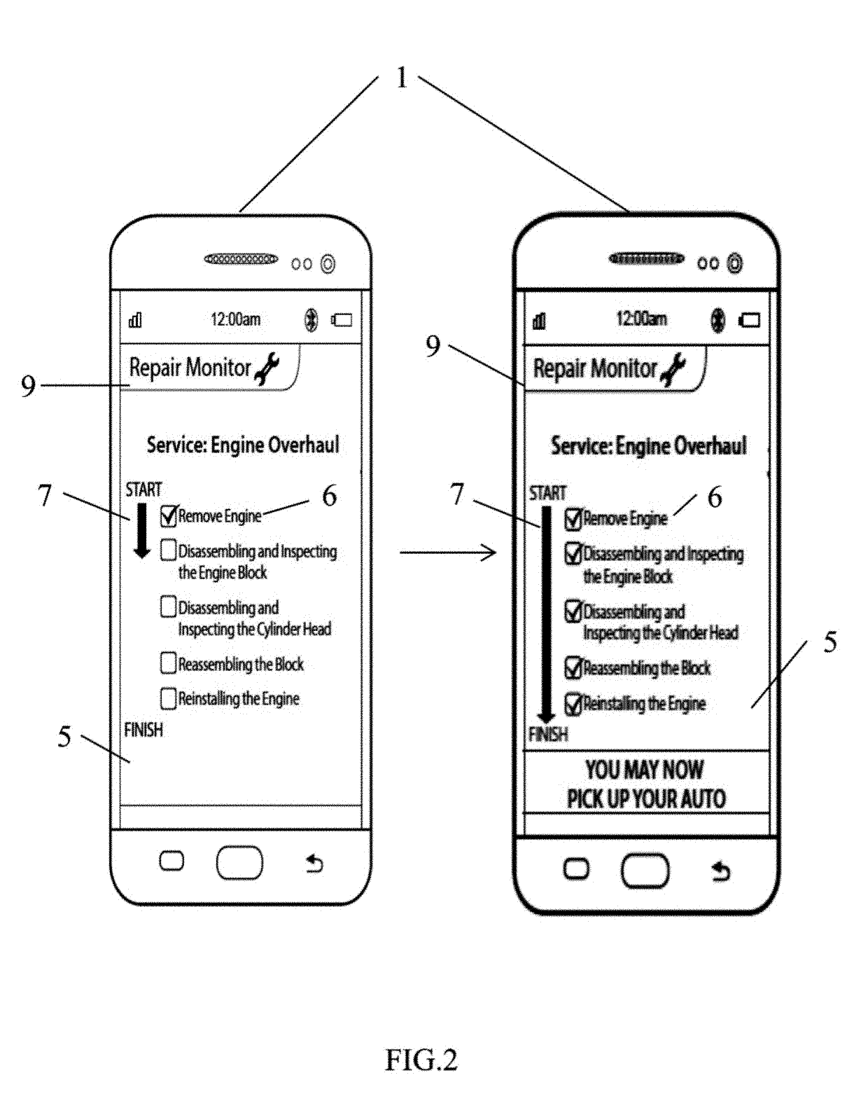

FIG. 2 is a schematic block diagram illustrating one embodiment of the present invention for checking vehicle service status in real-time. The mobile application 5 presents the status of the vehicle to a user on the user device 1. In one embodiment, the status is presented within a status interface (repair monitor) 9 on a display of the user device 1. The repair monitor 5 interface may include various fields indicating a status of the vehicle, a predicted completion time, a status of a scheduled service, a suggested service, and/or other information.

In one exemplary embodiment, if a user request vehicle engine service to the vendor service facility 2 by sending a service request from user device 1 to the vendor device 3 through the server 8 via the communication network 4. The mobile application 5 running on the user device 1 shows a repair monitor module 9 that allows a user to view vehicle service status.

Further, the repaired monitor 9 shows a plurality of vehicle service event 6 along with a start to finish process bar 7. Further, the repair monitors module 9 shows the type of service requested by the user (for e.g. Service type: Engine overhaul). Further, the repair monitor is adapted to show the plurality of service event 6 (for e.g. as remove engine, disassembling and inspection of the engine block, disassembling and inspecting the cylinder head, reassembling the block and reinstalling the engine) as shown in FIG. 2. Further, the repair monitor module 9 is adapted to receive a completion notification from the vendor device 3 for at least one of the plurality of service event 6. After receiving the completion notification, the repair monitor 9 put a completion mark on the respective service event 6 and display to the user. Further, the repair monitor 9 is adapted to move the process bar 7 along with the completed service event. Further, the repair monitor 9 is adapted notifies about the vehicle service completion when each of the service events 6 is marked and the process bar 7 is reached to the finish point. Further, the repair monitor 9 allows a user to select a pick and drop option for delivery of the user vehicle after completion of the vehicle service.

Further, In one embodiment, the vehicle service event can be a cost estimate completed, repair authorized by owner, insurance approval, spare parts ordered, spare parts received, vehicle scheduled for repair, vehicle disassembled, supplemental damage report written, repair of supplemental damage approved by insurance, additional parts ordered, vehicle set up on repair equipment, structure and body repaired, panels installed, corrosion protection applied, metal work completed, vehicle primed for painting, vehicle painted, vehicle cleaned, vehicle refinished, repair completed and the like.

In certain embodiments, a particular software module (mobile application) may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

One skilled in the art will realize that there are many pieces of information that may be sent to the user that would be useful for the user to know during the servicing of the vehicle. For example, it would be useful to send the amount of time it took to complete the service event that was just completed. Additionally, it would useful to also send that estimated time for the service events that are yet to be completed. It would also be good to know how the service station did in completing a vehicle service event as compared to the estimated time for completing a certain vehicle service event.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A method for checking vehicle service status of a user vehicle located on at least one service vendor facility, the method comprising:
a) receiving a vehicle service request from a user device by a service vendor device through a server via wireless communication;
b) creating a vehicle service process for the user vehicle based on the vehicle service request, wherein the vehicle service process includes a plurality of vehicle service events for the user vehicle based on the vehicle service request;
c) storing the plurality of vehicle service event to a database;
d) receiving status for each of the plurality of vehicle service events of the user vehicle from the vendor device present at the vendor facility;
e) storing the status for each of the plurality of vehicle service events of the user vehicle in the database;
f) receiving a request from the user device to view a vehicle service status;
g) retrieving the status for each of the plurality of vehicle service events from the database;
h) transmitting the status for each of the plurality of vehicle service events to the user device; and
i) displaying the status for each of the plurality of vehicle service events on the user device.

2. The method of claim 1, wherein the vehicle service event is selected from the group of information including: vehicle service appointment, vehicle accessories, vehicle insurance, costing, estimate time, deals, service coupon, pick and drop, spare parts cost and availability.

3. A system for enabling a user to check repaired progress of a vehicle at a service station, comprising:
a) a user device that will create a vehicle service request at a selected service station;
b) a service station device that will receive the vehicle service request from the user device;
c) a network server for enabling the user device to communicate with the service station device by wireless communication;
d) whereby, the service station device will generate a plurality of vehicle service events to be completed by the service station to properly fix the vehicle of the user;
c) whereby the plurality of vehicle service events are stored on the service station device;
d) whereby as the service station completes each of the plurality of vehicle service events on the vehicle, the service station device will each time be updated with the completed vehicle service event, and then the service station device will send, through the network server, each of the updates to the user device thus displaying each of the one of the plurality of vehicle service events that have been completed.

4. The system of claim 3, wherein the updates sent to the user will include a time that was needed to complete the vehicle service event that was completed.

5. The system of claim 4, wherein the updates sent to the user will include a time that is needed for the vehicle service events that are yet to be completed.

6. The system of claim 5, wherein the updates sent to the user will include a comparison between the estimated time to complete a vehicle service event and the actual time that was needed to complete the vehicle service event.

7. The system of claim 6, wherein when a last vehicle service event has been completed, the service station device will be updated and the user device will display that the service station has completed work on the vehicle and that the vehicle is now ready to be picked up.
